(19) United States
(12) Patent Application Publication
(10) Pub. No.: US 2026/0197723 A1
(43) Pub. Date: Jul. 9, 2026

(54) L1 Measurement Configuration for Inter-Cell Mobility

(71) Applicant: Apple Inc., Cupertino, CA (US)

(72) Inventors: Hong He, San Jose, CA (US); Dawei Zhang, Saratoga, CA (US); Wei Zeng, Saratoga, CA (US); Haitong Sun, Saratoga, CA (US); Chunxuan Ye, San Diego, CA (US); Ankit Bhamri, Haar (DE); Seyed Ali Akbar Fakoorian, San Diego, CA (US); Oghenekome Oteri, San Diego, CA (US); Jie Cui, San Jose, CA (US); Qiming Li, Beijing (CN)

(21) Appl. No.: 19/124,172

(22) PCT Filed: Nov. 4, 2022
(86) PCT No.: PCT/CN2022/130000

§ 371 Date: Apr. 24, 2025

(51) Int. Cl. H04W 36/00

(52) U.S. Cl. CPC H04W 36/0058; H04W 36/0085

(57) ABSTRACT

This disclosure relates to techniques for performing lower level measurement configuration and activation in a wireless communication system. A network may provide one or more measurement configuration for one or more non-active inter-frequency cell. The network and/or UE may activate the measurement configuration(s). The UE may perform measurement and reporting according to the activated configuration(s).

### FIELD

The present application relates to wireless communications, and more particularly to systems, apparatuses, and methods for communication using enhanced layer 1 measurement configuration and activation for inter-cell mobility in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include Global System for Mobile Communication (GSM), Universal Mobile Telecommunication System (UMTS) (associated with, for example, WCDMA or TD-SCDMA air interfaces), Long Term Evolution (LTE), LTE Advanced (LTE-A), New Radio (NR), HSPA, 3GPP2 CDMA 2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for communication using enhanced layer 1 measurement configuration and activation for inter-cell mobility.

One set of embodiments may include a method. The method may include establishing communication with a first activated serving cell of a cellular network, the first activated serving cell operating on a first frequency layer. The method may include receiving, from the first activated serving cell, configuration information for layer 1 (L1)/layer 2 (L2)-Triggered Mobility (LTM) operation comprising a L1 measurement configuration for a non-active second cell, the non-active second cell operating on a second frequency layer that is different from the first frequency layer. The method may include determining, based on the L1 measurement configuration, information for measuring reference signals (RS) transmitted on the non-active second cell for triggering LTM operation. The information for measuring RS on the non-active second cell for triggering LTM operation may comprise at least one of: a frequency location of RS transmitted on the non-active second cell; or a subcarrier spacing of the RS transmitted on the non-active second cell. The method may include performing an L1 measurement of the non-active second cell according to the information for measuring the RS on the non-active second cell and reporting the L1 measurement to the cellular network.

One set of embodiments may include a method. The method may include establishing communication with a first activated serving cell of a cellular network, the first activated serving cell operating on a first frequency. The method may include receiving, from the first activated serving cell, configuration information for layer 1 (L1)/layer 2 (L2)-Triggered Mobility (LTM) operation comprising a first L1 measurement configuration for a non-active second cell, the non-active second cell operating on a second frequency layer that is different from the first frequency. The method may include, in response to an indication specifying the second frequency layer: performing an L1 measurement according to the first L1 measurement configuration for the non-active second cell, and reporting the L1 measurement to the cellular network.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings.

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 is a communication flow diagram illustrating aspects of an exemplary possible method for communication using measurement configuration for non-active inter-frequency cell(s) in a wireless communication system, according to some embodiments.

FIGS. 6-19 illustrate exemplary aspects of various possible approaches to communication using measurement configuration for non-active inter-frequency cell(s) in a wireless communication system, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDA s, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

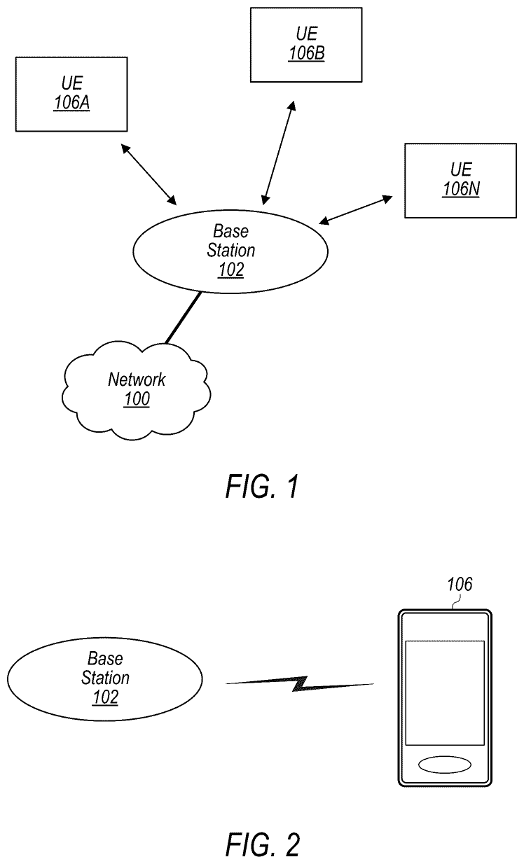

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink (UL) and downlink (DL) communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA 2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for communication using enhanced layer 1 measurement configuration and activation for inter-cell mobility in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA 2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA 2000 1×RTT (or LTE or NR, or LTE or GSM), and separate radios for communicating using each of Wi-Fi and BLUETOOTH™. Other configurations are also possible.

In some embodiments, the UE 106 may include multiple subscriber identity modules (SIM s, sometimes referred to as SIM cards). In other words, the UE 106 may be a multi-SIM (MUSIM) device, such as a dual-SIM device. Any of the various SIM s may be physical SIM s (e.g., SIM cards) or embedded (e.g., virtual) SIM s. Any combination of physical and/or virtual SIM s may be included. Each SIM may provide various services (e.g., packet switched and/or circuit switched services) to the user. In some embodiments, UE 106 may share common receive (Rx) and/or transmit (Tx) chains for multiple SIM s (e.g., UE 106 may have a dual SIM dual standby architecture). Other architectures are possible. For example, UE 106 may be a dual SIM dual active architecture, may include separate Tx and/or Rx chains for the various SIM s, may include more than two SIM s, etc.

The different identities (e.g., different SIM s) may have different identifiers, e.g., different UE identities (UE IDs). For example, an international mobile subscriber identity (IMSI) may be an identity associated with a SIM (e.g., in a MUSIM device each SIM may have its own IMSI). The IMSI may be unique. Similarly, each SIM may have its own unique international mobile equipment identity (IMEI). Thus, the IMSI and/or IMEI may be examples of possible UE IDs, however other identifiers may be used as UE ID.

The different identities may have the same or different relationships to various public land mobile networks (PLMNs). For example, a first identity may have a first home PLMN, while a second identity may have a different home PLMN. In such cases, one identity may be camped on a home network (e.g., on a cell provided by BS 102) while another identity may be roaming (e.g., while also camped on the same cell provided by BS 102, or a different cell provided by the same or different BS 102). In other circumstances, multiple identities may be concurrently home (e.g., on the same or different cells of the same or different networks) or may be concurrently roaming (e.g., on the same or different cells of the same or different networks). As will be appreciated, numerous combinations are possible. For example, two SIM subscriptions on a MUSIM device may belong to the same equivalent/carrier (e.g., AT&T/AT &T or CMCC/CMCC). As another exemplary possibility, SIM-A may be roaming into SIM-B's network (SIM-A CMCC user roaming into AT&T and SIM-B is also AT&T).

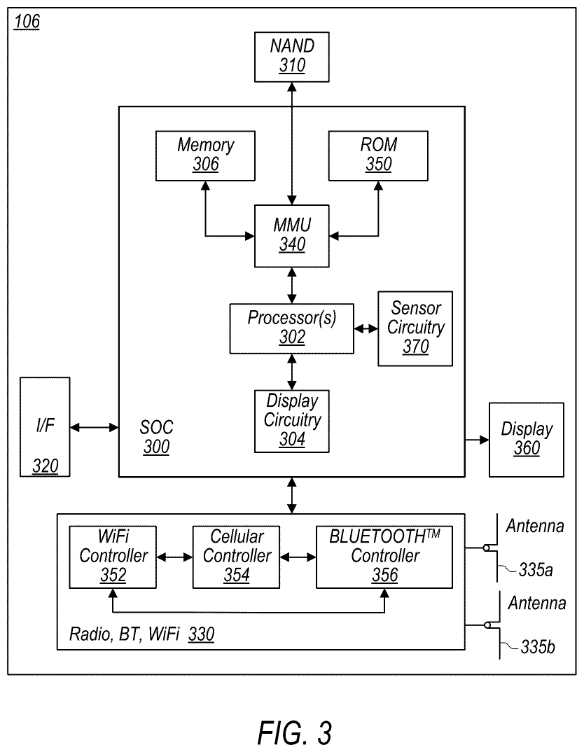

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA 2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for communication using enhanced layer 1 measurement configuration and activation for inter-cell mobility in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for communication u enhanced layer 1 measurement configuration and activation for inter-cell mobility in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

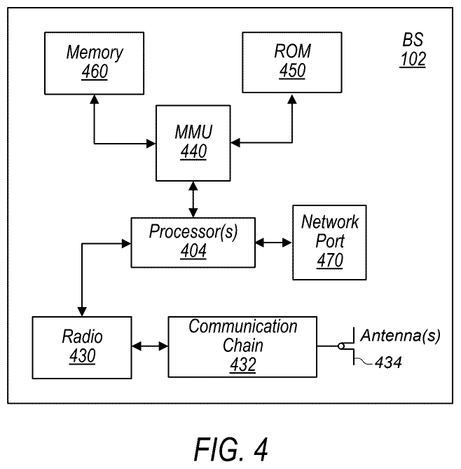

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA 2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UM TS, LTE and CDMA 2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource group for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided.

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g., where R represents the number of layers, Nₜ represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

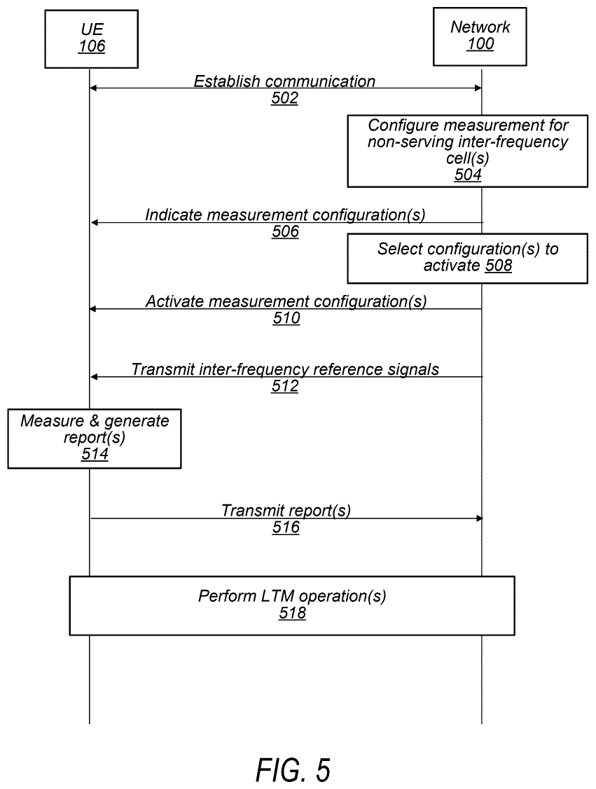

### FIG. 5—Configuration, Activation, and Deactivation of L1 Inter-frequency Measurements

According to some cellular communication technologies, it may be possible for a UE to communicate with multiple cells, including potentially simultaneously. New mobile services that benefit from low-latency and high reliability performance (e.g., ultra-reliable low latency communication (URLLC)) are emerging. While the 5G standard has been designed to address these services from the start, the evolution of 5G New Radio (NR), further enhancement to the mobility robustness performance for these challenging scenarios may be desired. Low level (e.g., layer 1 (L1)) based measurements and mobility may support this robustness.

In RAN plenary 94-e meeting, one work item (“NR mobility enhancements”) was approved with the following objective: L1 enhancements for inter-cell beam management (ICBM), including L1 measurement and reporting, and beam indication [RAN1, RAN2]. In RAN2 119e meeting, it was agreed regarding the target use case of L1/L2-based inter-cell mobility to support both intra-frequency and inter-frequency L1/L2-based mobility. On L1-based measurement, it was agreed in RAN 1 109 bis-e meeting that RAN 1 may assume Rel-17 ICBM CSI measurement as starting point and that synchronization signal block (SSB) may be at least supported for L1 intra-frequency/inter-frequency measurement. The details of L1 CSI measurement enhancement for inter-frequency case remains open.

To illustrate one set of possible techniques for measurement and mobility, FIG. 5 is a flowchart diagram illustrating a method for performing configuration and/or activation of measurements and reporting in a wireless communication system, at least according to some embodiments. Aspects of the method of FIG. 5 may allow the UE and network to: 1) configure L1 measurements for various cells (e.g., such as deactivated secondary cells (SCells) and non-serving cells) such that the L1 measurement (e.g., reference signal received power (RSRP)) reporting for these candidate cells may be provided to network (e.g., to decide the L1 handover triggering) and 2) activate and/or deactivate L1 measurement (e.g., RSRP) reporting in a manner that controls/limits the power consumption of L1 measurement and signaling overhead of (e.g., CSI) reporting, e.g., to achieve efficient L1 measurement and reporting.

Aspects of the method of FIG. 5 may be implemented by a wireless device, e.g., in conjunction with one or more cellular base stations of a network 100, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

The UE may establish a wireless link with a network (502), according to some embodiments. According to some embodiments, the wireless link may include a cellular link according to 5G NR. For example, the UE may establish a session with an AMF entity of the cellular network by way of one or more base stations (e.g., TRPs and/or gNBs) that provide radio access to the cellular network. As another possibility, the wireless link may include a cellular link according to LTE. Other types of cellular links are also possible, and the cellular network may also or alternatively operate according to another cellular communication technology (e.g., UMTS, CDMA 2000, GSM, etc.), according to various embodiments.

Establishing the wireless link may include establishing a radio resource control (RRC) connection with a serving cellular base station (e.g., providing a primary serving cell), at least according to some embodiments. Establishing the RRC connection may include configuring various parameters for communication between the UE and the cellular base station, establishing context information for the UE, and/or any of various other possible features, e.g., relating to establishing an air interface for the UE to perform cellular communication with a cellular network associated with the cellular base station. After establishing the RRC connection, the UE may operate in a RRC connected state. In some instances, the RRC connection may also be released (e.g., after a certain period of inactivity with respect to data communication), in which case the UE may operate in a RRC idle state or a RRC inactive state. In some instances, the UE may perform handover (e.g., while in RRC connected mode) or cell re-selection (e.g., while in RRC idle or RRC inactive mode) to a new serving cell, e.g., due to UE mobility, changing wireless medium conditions, and/or for any of various other possible reasons.

The wireless link may be or include a link with a first activated serving cell, e.g., a first cell. As one possibility, the first cell may be a primary cell. In some embodiments, the first cell may not be a primary cell, e.g., it may be a secondary cell. The wireless link may include links with any number of other cells.

In some embodiments, the UE may indicate relevant UE capability information to the network, e.g., describing its capabilities such as bandwidth and/or timing for various types of measurement and reporting. For example, given the significant complexity of aperiodic measurement of non-serving cells (e.g., A-CSI), a new UE capability may be introduced to indicate the support of A-CSI reporting on a non-serving cell. For example, a larger aperiodicTriggeringOffset value may be indicated by UE for aperiodic CSI-RS resources on non-serving cell. Thus, one value of aperiodicTriggeringOffset may be provided for serving cells and a second (potentially larger or otherwise different) value of aperiodicTriggeringOffset may be provided for non-serving cells. Additional capabilities or parameters may be included.

The network may determine configuration(s) for the UE for measurement of one or more other cell(s) (504), according to some embodiments. The measurement configuration(s) may be or include configuration information for L1/L2-Triggered Mobility (LTM) operation, according to some embodiments.

A measurement configuration may specify the following parameters, according to some embodiments. A CSI-ReportConfig may specify how and/or when the measurement(s) should be reported to the network (e.g., format, content, and/or destination for the report(s)). A CSI-ReportConfig may be an example of an L1 measurement configuration. A CSI-ReportConfigId may identify a configuration. For example, the network may configure a list of L1 measurement configurations for the UE, with each configuration identified by a CSI-ReportConfigId. A reportConfigType may indicate whether an associated CSI-ReportConfig is periodic, semi-persistent, or aperiodic. A CSI-SSB-ResourceSet may specify the reference signals to be measured.

For example, the network may determine configuration for one or more CSI reports and/or other measurement and/or reporting of the other cell(s). The measurement configuration(s) may be periodic (e.g., P-CSI), semi-persistent (SP) (e.g., SP-CSI), and/or aperiodic (e.g., A-CSI), among various possibilities. The network may determine on or more configurations for any particular other cell or frequency layer. The network may determine groups of measurement configurations to trigger or activate together, according to some embodiments.

The measurement configuration(s) may include layer 1 (L1) measurements, among various possibilities. For example, L1 RSRP, SNR, SINR, and/or other measurements may be configured.

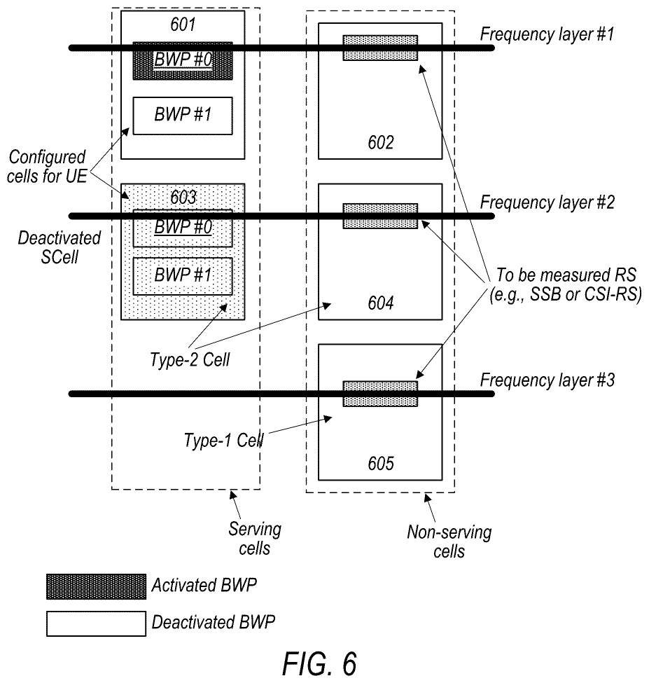

The other cell(s) may be non-active, e.g., deactivated secondary cell(s) and/or non-serving (e.g., not yet activated or configured) cells. For example, the other cells that may be configured with L1 measurement for L1/L2-based inter-cell mobility (e.g., L1/L2-Triggered Mobility (LTM)) maybe categorized into two types as illustrated in FIG. 6, according to some embodiments.

A type-1 cell may be a cell where the (e.g., measured) RS of the cell is not covered (e.g., on the same frequency as) any of the configured cells for the UE. For example, a type 1 cell may not overlap the bandwidth part(s) (BWP) of any primary or secondary cell configured for the UE.

A type-2 cell may be a cell where the (e.g., measured) RS of the cell is covered by at least one deactivated secondary cell (Scell) configured for the UE. For example, a type 2 cell may overlap a configured BWP of a deactivated SCell and/or the deactivated SCell may be considered a type-2 cell. Thus, a type-2 cell may be a RRC-configured SCell that is deactivated. Further, type-2 cell may be a non-serving cell (e.g., a cell that is not configured for the UE) that is covered by a deactivated SCell (or SCells) in frequency domain. In some embodiments, the cells in FIG. 6 can be categorize as follows:

Cell 601 may be an active serving cell. For example, cell 601 may be a primary serving cell or a secondary serving cell. Cell 601 may be the first cell (e.g., as discussed with respect to 502). Cell 601 may be neither type-1 nor type-2.

Cell 602 may be neither type-1 nor type-2, e.g., because 602 overlaps the frequency of 601. According to some embodiments, the L1 measurement on cell 602 can be supported by directly reusing Rel-17 inter-cell beam management (ICBM) framework already without need of enhancement. Note that, even if frequency layer 1 overlapped deactivated BWP #1 rather than activated BWP #0, cell 602 would be neither type-1 nor type-2.

Cell 603 may be a type-2 cell. Specifically, 603 may be a deactivated Scell, and therefore may be categorized as type 2.

Cell 604 may be a type-2 cell. Specifically, 604 may overlap with a deactivated Scell (e.g., 603), and therefore may be categorized as type 2.

Cell 605 may be a type-1 cell. Specifically, 605 may be a non-serving cell and may not overlap with any serving cell (e.g., activated cell 601 or deactivated cell 603), and therefore may be categorized as type 1.

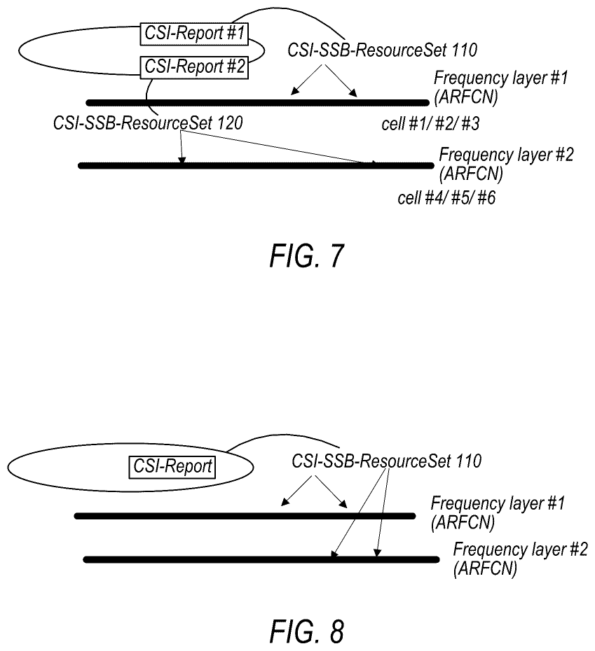

The measurement configurations may include a variety of enhancements relative to Rel-17 Inter-cell Beam Management framework (ICBM) for type-1 cells and/or type-2 cells. FIG. 7 and FIG. 8 illustrate example measurement configurations, according to some embodiments. For example, for L1-RSRP measurement, one CSI report may be configured on a serving cell (e.g., the first cell) to link with a CSI-SSB-Resource set that includes SSB(s) on one or more Type-1 and/or Type-2 other cell(s). The other cells may have different physical cell identities (PCIs) on same and/or different frequency layers, as depicted.

FIG. 7 illustrates two L1 measurement configurations, according to some embodiments. A first configuration (CSI report #1) is configured for cells 1, 2, and 3 using CSI-SSB-ResourceSet 110 on frequency layer 1. A second configuration (CSI report #2) is configured for cells 4, 5, and 6 using CSI-SSB-ResourceSet 120 on frequency layer 2. These configurations may or may not be grouped (e.g., they may be activated together or separately). As shown, the frequency layers may be identified by absolute radio-frequency channel number (ARFCN), according to some embodiments.

FIG. 8 illustrates one L1 measurement configuration, according to some embodiments. A configuration (CSI report) is configured for one or more cells using CSI-SSB-ResourceSet 110 on frequency layer 1 and one or more cells using CSI-SSB-ResourceSet 110 on frequency layer 2.

A measurement configuration may include a frequency layer (e.g., ARFCN) and any number of RS. The RS may be identified by type and/or a specific instance of the RS (e.g., a configuration may specify particular SSB instances, e.g., SSB #1, 2, 5 and 8, etc.). A configuration may specify the cell(s) to which it applies, e.g., by frequency layer, PCI, and/or other identifier.

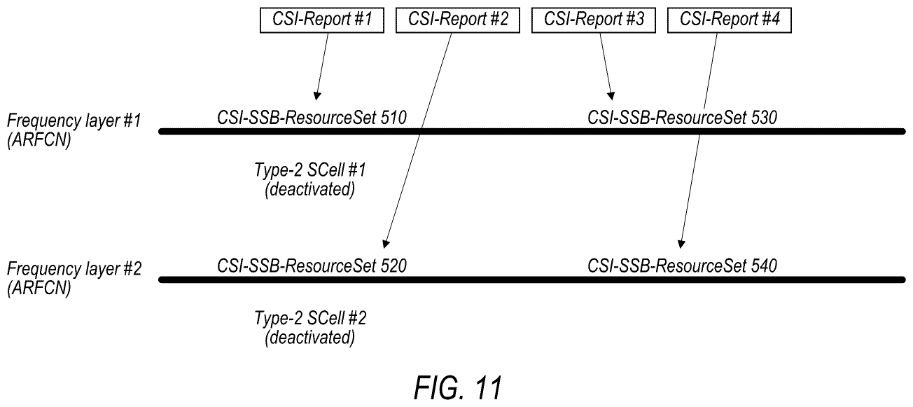

FIG. 11 illustrates an example measurement configuration for type 1 (e.g., non-serving cell not overlapping a serving cell) and/or type 2 cells (e.g., deactivated SCell and type-2 non-serving cell), according to some embodiments. As shown, a UE may be configured with a CSI report associated with one or more CSI-SSB-Resourceset on one or more deactivated SCell and/or type 2 non-serving cell. For example, four CSI reports (#1, #2, #3, and #4) may be configured. CSI reports #1 and #2 may be associated with deactivated type-2 SCell #1 and SCell #2. CSI reports #3 and #4 may be associated with type-2 non-serving cell #3 and #4, respectively. The reportConfigType maybe set to be ‘periodic’, ‘semiPersistent’, or ‘aperiodic’.

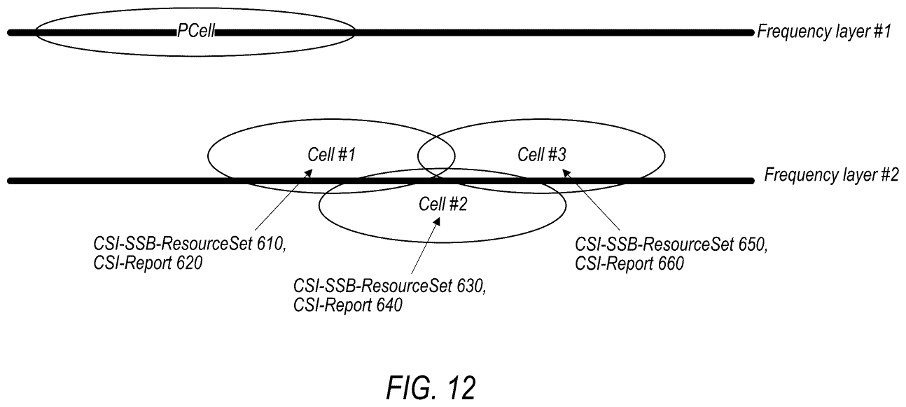

FIG. 12 illustrates an example measurement configuration for type 1 and/or type 2 cells, according to some embodiments. In particular, FIG. 12 illustrates non-serving cells (as opposed to deactivated serving cells, which may be examples of type 2). For example, three CSI reports (620, 640, 660) may be configured for type-1 cells #1, #2, and #3 on a same frequency layer (#2) using CSI-SSB-ResourceSets 610, 630, and 650, respectively.

The network may indicate the L1 measurement configuration(s) for other cell(s) to the UE (506), according to some embodiments. The indication may be transmitted in one or more messages. For example, the indication may be provided via radio resource control (RRC) signaling. The indication may be transmitted in configuration of the first cell, configuration of the other cell(s), a combination of both, or separately.

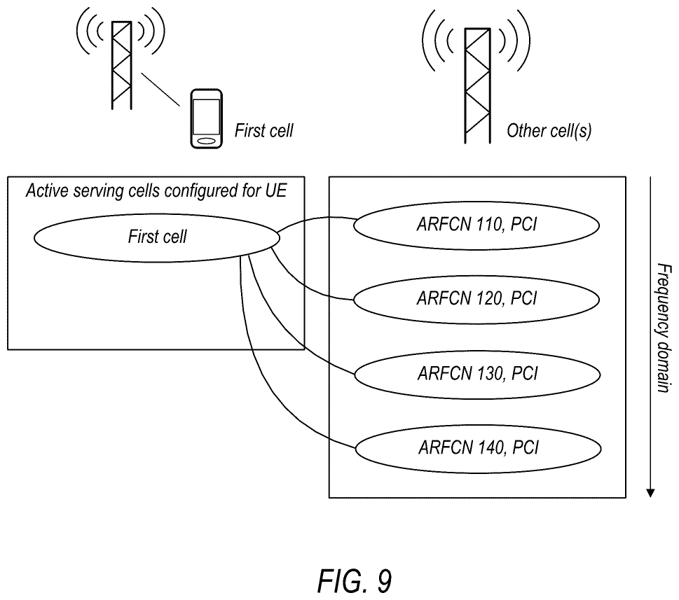

FIG. 9 provides one example of inter-frequency L1 measurement using a CSI-SSB-ResourceSet as proposed herein, according to some embodiments. At least one active cell and one or more other cells may be in the area of the UE. For example, three cells (e.g., a primary cell (PCell), SCell #1, and SCell #2) may be configured for the UE, where SCell #1 and SCell #2 are deactivated, among various possibilities. The network may indicate configuration of L1 measurement for the non-active cells according to either of two options as shown in the following table, e.g., specifying separate configurations for individual frequency layers or configuring multiple frequency layers together in a single configuration. It will be appreciated that the values shown in the table are examples and other values may be used as desired. Moreover, the options may be used in combination, e.g., some configuration(s) may be indicated separately and other configurations indicated together.

| Option | Configuration(s) for other cell(s) |
|---|---|
| 1—separate | CSI-SSB-ResourceSet #1: ARFCN 110, SSB #1/2/3 |
| indication | CSI-SSB-ResourceSet #2: ARFCN 120, SSB #1/4/8 |
| | CSI-SSB-ResourceSet #3: ARFCN 130, SSB #5/8/10 |
| | CSI-SSB-ResourceSet #4: ARFCN 140, SSB #7/23/25 |
| 2—combined | CSI-SSB-ResourceSet #1: ARFCN |
| indication | 110/110/110/120/120/120/130/130/130/140/140/140, |
| | SSB #1/2/3/1/4/8/5/8/10/7/23/25 |

According to either option, the resulting configurations may be the same, e.g., in combination. For example, for ARFCN 110, the UE may be configured to measure SSB #1/2/3 and for ARFCN 120, the UE may be configured to measure SSB #1/4/8, etc. according to either option.

As one possibility, the network may configure UE to perform L1 measurement on non-active cells, by providing indication(s) of the cell(s) in CSI-SSB-ResourceSet with a set of indicated SSB s.

In some embodiments, one or more new Information Element (IE) may be used for indicating the L1 measurement configuration(s). For example, the new IE(s) may be used for CSI-SSB-ResourceSet configuration associated with one or more non-active cell (such as a type-1 cell).

A first new IE may indicate the frequency location(s) of the RS, e.g., SSBs in a CSI-SSB-ResourceSet. In some designs, the “ARFCN-ValueNR” may be used to indicate the frequency location of SSBs in the CSI-SSB-ResourceSet for a cell. This IE may be used with either of the options discussed above.

According to option 1, the ARFCN-ValueNR may be provided on a per configuration (e.g., per CSI-SSB-ResourceSet) basis. According to this option, the SSBs associated with a CSI-SSB-ResourceSet for CSI reporting may be limited to a single frequency.

According to option 2, a list of one or more ARFCN-ValueNR values may be configured for a configuration (e.g., CSI-SSB-ResourceSet). Thus, if present, the ARFCN-ValueNR list may have a same number of entries as PCIs in the CSI-SSB-ResourceSet. In other words, a frequency location may be provided for each of a number of cells (e.g., indicated by PCI) in the configuration.

A second new IE may indicate the subcarrier spacing (SCS) (or SCSs) of the RS, e.g., SSBs in a CSI-SSB-ResourceSet. In some designs, if the SCS IE is not present, a default value (e.g., same as the SCS of a primary cell or same as the active BWP of the serving cell where the CSI-SSB ResourceSet is configured) may be assumed at the UE side. This IE may be used with either of the options discussed above.

According to option 1, a single SCS value for all SSBs in a configuration (e.g., CSI-SSB-ResourceSet) may be indicated.

According to option 2, a list of one or more SCS values may be indicated for a configuration (e.g., CSI-SSB-ResourceSet). For example, each SSB in a CSI-SSB-ResourceSet being associated with a SCS.

In the case of option 2, a third new IE may be included, e.g., listing the cell(s) in the configuration (e.g., CSI-SSB-ResourceSet). This IE may provide an ordered list of non-active cells for which the configuration is applicable. The lists described above with respect to option 2 and the first and second new IEs, may be ordered consistently with this list, e.g., so that the first entry on each of the lists may correspond to a same cell.

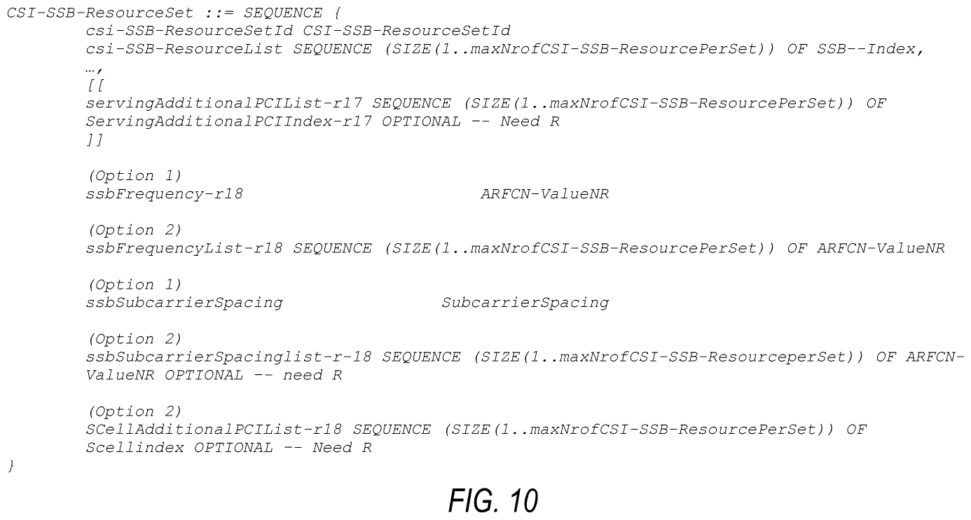

FIG. 10 illustrates an exemplified ASN.1 code to implement options for indication of frequency location and SCSs of SSB for L1 measurement, according to some embodiments. As shown, the configuration may include the IEs discussed above (e.g., according to either of option 1 or option 2). The configuration may include any of the following:

ssbFrequency: may indicate the frequency layer (e.g., ARFCN) of the SS associated to this CSI-SSB-ResourceSet.

ssbFreqeuncyList: may have the same number of entries as csi-SSB-ResourceList. The first entry of the list may indicate the value of the frequency layer (e.g., ARFCN) for the first PCI of csi-SSB-ResourceList, the second entry of this list may indicate the value for the second PCI, and so on.

ssbSubcarrierSpacing: may indicate the subcarrier spacing of SSB associated to this CSI-SSB-ResourceSet.

ssbSubcarrierSpacingList: may have the same number of entries as csi-SSB-ResourceList. The first entry of the list may indicate the value of the SCS for the first PCI of csi-SSB-ResourceList, the second entry of this list may indicate the value for the second PCI, and so on.

AdditionalPCIList: may have the same number of entries as csi-SSB-ResourceList. The first entry of the list may indicate the value of the PCI for the first PCI of csi-SSB-ResourceList, the second entry of this list may indicate the value for the second PCI, and so on.

In some embodiments, the CSI report for one or more type-1 and/or type-2 non-serving cell may be configured as part of the type-1 cell configuration and/or type-2 non-serving cell configuration during a handover preparation phase. For example, this may be the case for configurations similar to those illustrated in Figured 12. In some embodiments, the CSI report(s) may be configured prior to the handover preparation phase and activated during the handover preparation phase. Regardless of when the configuration occurs, the IEs discussed above may be used if desired or alternative means of configuration may be used.

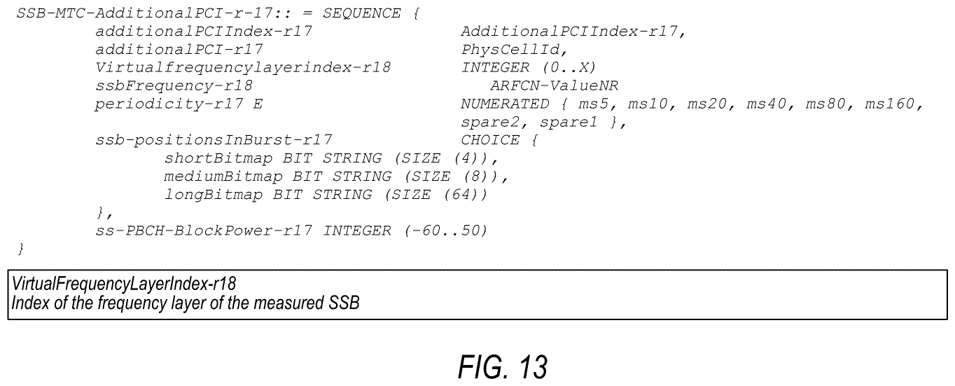

According to some embodiments, for a type-1 cell, a UE may be configured with a virtual frequency layer ID (VFID) for the cell. The VFID(s) for type 1 cells may be provided to the UE via RRC signaling. For example, the VFID may be provided in a SSB-MTC-AdditionalPCI IE as illustrated in FIG. 13, according to some embodiments. FIG. 13 provides an example ASN.1 structure for an enhanced SSB-MTC-AdditionalPCI IE by adding VFID information for a frequency layer associated with a type-1 cell. The IE may associate a type 1 cell (e.g., via the VFID) with a frequency layer (e.g., via the ARFCN-ValueNR). The VFIDs may be indexed in various ways. VFIDs may be UE specific, e.g., different UEs may have the same or different VFID values for a same cell.

In some embodiments, the value of VFIDs may be sequentially indexed after the index of SCells configured for a UE. In other words, a first VFID may have an index value that is 1 greater than a highest index of any configured SCell for the UE.

In some embodiments, the value of VFIDs may be numbered starting from 0. Thus, a VFID value may be independent compared to any SCell index.

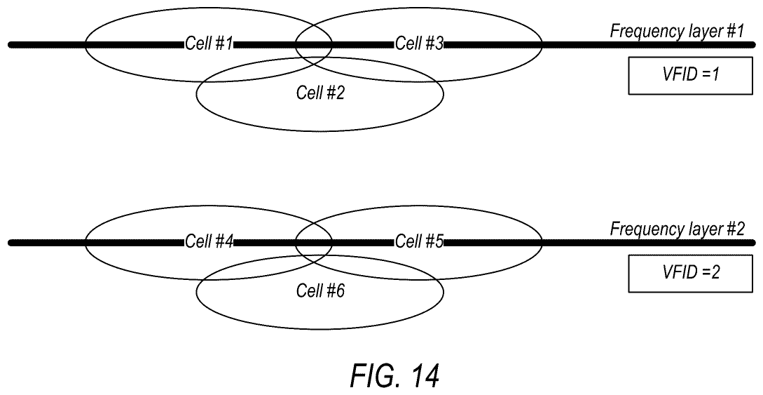

FIG. 14 shows one example of VFIDs, according to some embodiments. In the illustrated example, three type-1 cells (cell #1, #2, and #3) are located in frequency layer #1 and another three type-1 cells (cell #4, #5, and #6) are located on frequency layer #2. The network may provide the UE with VFID=1 for frequency layer #1 and VFID=2 for frequency layer #2. These VFID may be used in any subsequent activation operation for CSI report on these type-1 cells and/or in any resulting CSI report.

In some designs, (e.g., for SSB resource(s) on a type-2 cell that is associated with a measurement configuration), the configuration may indicate the quasi co-location (QCL) source and/or transmission configuration indicator (TCI) state. Providing this information via higher layer configuration (e.g., in 506) may reduce the L1 measurement latency This may be beneficial in the case of aperiodic measurements triggered under various circumstances (e.g., in 510). However, the QCI and/or TCI information may be provided later (510) or may be omitted, if desired.

The network may transmit the indication to the UE via any serving cell(s). For example, a primary cell or a secondary cell may transmit the indication.

The measurement configuration may be included as part of configuration of one or more cell(s). For example, an L1 measurement configuration for a non-active cell may be included as part of configuration of an active cell such as the first cell, a primary cell, etc. An L1 measurement configuration for a non-active (e.g., deactivated) second cell may be included as part of configuration of the non-active second cell.

The network may select one or more measurement configuration to activate (508), according to some embodiments. For example, the network may select the configuration(s) to activate based on mobility of the UE, traffic patterns of the UE, traffic volume of the UE, load on any cell(s) or other component(s) of the network, and/or other factors. The network may similarly select any configuration to deactivate. The configuration(s) may be periodic, semi-persistent, and/or aperiodic. All or any subset of the configuration(s) that are configured for the UE (e.g., in 504, 506) may be selected.

In some embodiments, measurement configurations for type-2 cells may remain deactivated by default. They may be activated (e.g., by the network) to facilitate cell switching by the UE based on the L1 measurement(s).

In some embodiments, some configurations may be activated when they are configured (e.g., during 504, 506). For example, some configurations may be active by default. In some embodiments, the determination to activate a configuration may be made at the same time the configuration is configured and thus an indication to activate the configuration may be sent at the same time. Accordingly, 508 (and similarly 510) may be omitted in some embodiments.

The network may transmit an indication to the UE to activate the measurement configuration(s) (510), according to some embodiments. The indication may use RRC, media access control (MAC) control element (MAC-CE), and/or downlink control information (DCI) signaling, among various possibilities. For example, a variety of approaches may be used to activate/deactivate one or more CSI-ReportConfig associated with type-1 and/or type-2 cells depending on a reportConfigType.

As one possibility, for periodic (P) or semi-persistent (SP) reporting (e.g., CSI-ReportConfig), a MAC-CE may be used. For example, a new type of MAC-CE may be used to activate the RRC-configured (e.g., in 506) P/SP CSI-ReportConfig. The configuration(s) may be activated on a ‘per frequency layer’ basis. The new MAC-CE may be identified by a MAC sub-header with a dedicated logical channel identifier (LCID). The new MAC-CE may be structured in a single frequency layer design or a multiple frequency layer design, among various possibilities.

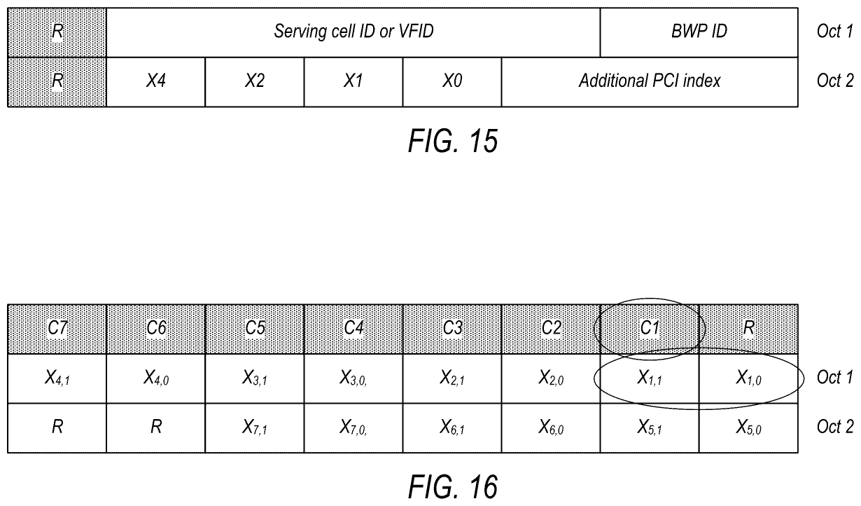

FIG. 15 illustrates a single frequency layer MAC-CE design, according to some embodiments. Various fields are described below.

The MAC-CE may include a serving cell ID (for type-2 serving cells) or VFID (for type-1 or type-2 non-serving cells). This field may indicate identity of the frequency layer where the indicated type 2 SCell or VFID is located.

The MAC-CE may include a BWP-ID field. This field may indicate a BWP, e.g., for which the MAC-CE applies. For example, the BWP may be within the frequency layer. In some embodiments, a default BWP may be predefined (by RRC or 3GPP standard) and the BWP-ID field may be omitted.

The MAC-CE may include an additional PCI index field. This field may indicate the index of the cell (e.g., additional PCI) for CSI report activation. For example, if a VFID is used and potentially refers to multiple cells on that frequency, the additional PCI field may indicate which of the multiple cells the UE should measure and report.

The MAC-CE may include one or more fields Xᵢ. In the illustrated example, i ranges from 0 to 4, but other values are possible. The Xᵢ field may indicate the activation/deactivation status of the ‘ith’ P/SP CSI report. For example, X₀ may refer to the P or SP CSI-report which include CSI resource(s) (e.g., CSI-RS or SSB) in the indicated BWP of the indicated cell(s) and has the lowest CSI-ReportConfigId within the list of (e.g., L1) measurement configurations for the UE.

R may indicate a reserved field or bit.

FIG. 16 illustrates a multiple frequency layer MAC-CE design, according to some embodiments. Various fields are described below.

The MAC-CE may include one or more fields Cᵢ. A Cᵢ field may indicate the frequency layer of the index of SCell with SCellIndex ‘i’ (for type-2 serving cells) or frequency layer with VFID ‘i’ (type-1 cells and/or non-serving type 2 cells) where the MAC-CE is applied. In other words, this field may indicate a frequency layer for which a measurement configuration is to be activated or deactivated. In the illustrated example, i ranges from 1 to 7, but other values are possible. For example, i<32 or i<64 may be considered. Such a design choice may balance between overhead and L1 measurement flexibility.

The MAC-CE may include one or more fields X_{i,j}. An X_{i,j} field may indicate the activation/deactivation status of ‘jth’ P/SP CSI report associated with CSI resources of a type-1 or type-2 cell on the indicated ‘ith’ frequency layer. “j” may be an index of the measurement configurations for the ‘ith’ frequency layer. For example, j=0 may be associated with a lowest CSI-ReportConfigId and j=1 may be associated with second lowest CSI-ReportConfigId and so on.

In some embodiments, the P/SP report may be for RS in a pre-defined BWP of the frequency layer (e.g., such a predefinition may be configured for the measurement configuration in 504 and 506). In some designs, the first (e.g., lowest index) downlink BWP of a type-1 or type-2 cell may be set (e.g., in 3GPP specification or by RRC) as the pre-defined BWP for an L1 measurement report. With this design, the BWP ID may not be indicated in MAC-CE format as illustrated in FIG. 16. Alternatively, one or more BWP-ID fields (similar to that discussed with respect to FIG. 15) may be included in a multiple frequency layer MAC-CE design.

In some designs, only one P/SP-CSI report may be supported for a frequency layer for L1 measurement. With this restriction, ‘X_{i,j}’ fields in FIG. 16 may be omitted and only Cᵢ fields may be included in the MAC-CE format.

In the example illustrated in FIG. 16, i<8. In other words, this example MAC-CE may support P/SP-CSI report activation on up to 8 frequency layers including type-1 and/or type-2 cells. Note that more than 1 cell may exist per layer. For each frequency layer, up to two P/SP-CSI reports can be associated to perform L1 measurement, e.g., for cell switching. Hence, j=0 or 1. Thus, in FIG. 16, the field ‘X_{1,0}’ and ‘X_{1,1}’ in the MAC-CE may be used to activate/deactivate the first and/or the second P/SP CSI reports on the frequency layer #1. In some embodiments, j may be greater than 1.

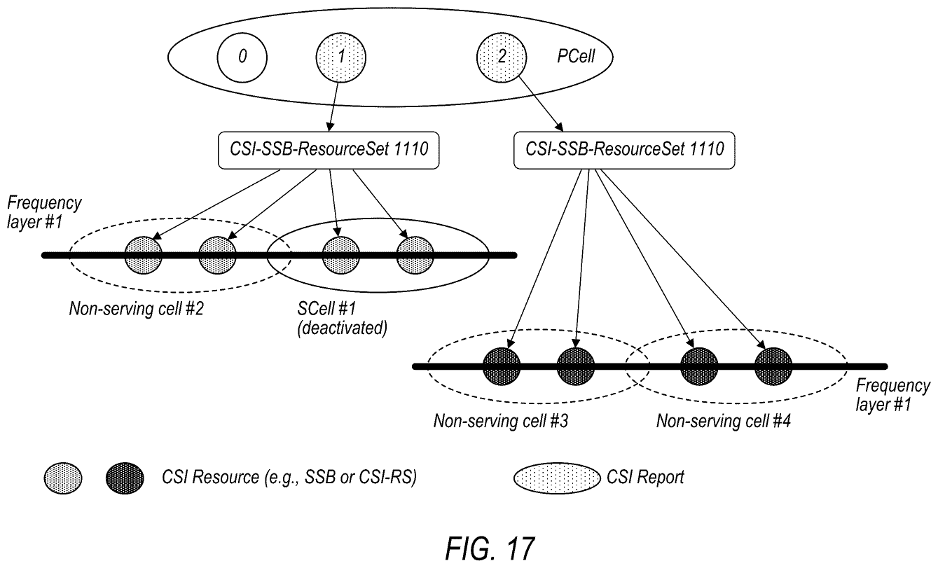

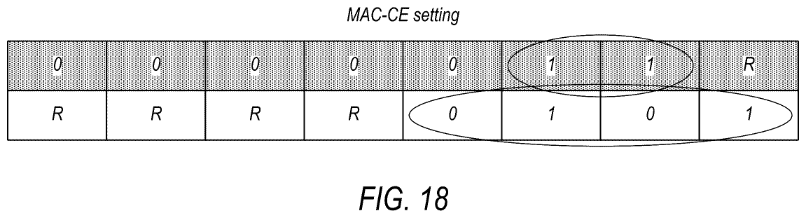

FIGS. 17 and 18 provide one example regarding how to activate multiple frequency-layer CSI-reports associated with type-1 and/or type-2 cells, according to some embodiments. The cells may be on one or more frequency layer and may include deactivated SCell(s) and/or intra-frequency non-serving cells. The configurations may include performing L1 measurement and the resulting measurement report(s) may be used for triggering LTM operation including L1 initiated handover.

Referring to FIG. 17, 3 P/SP CSI-reports may be configured on a primary cell (PCell) for a UE. The P/SP CSI report #1 may be associated with a CSI-SSB-ResourceSet 1110 which includes CSI resources (e.g., SSB) on deactivated SCell #1 and an intra-frequency (relative to SCell #1, but inter-frequency relative to the PCell) type-2 non-serving cell #2 on frequency layer #1. Both SCell #1 and non-serving cell #2 may be type 2 cells. In other words, CSI report #1 may be a first measurement configuration (e.g., identified by a first CSI-ReportConfigId) covering multiple non-active cells on a first single frequency layer.

The P/SP CSI report #2 may be associated with a CSI-SSB-ResourceSet 1120 which includes CSI resources (e.g., SSB) on type-1 cells #3 and #4 on frequency layer #2. CSI report #2 may be a second measurement configuration (e.g., identified by a second CSI-ReportConfigId) covering multiple non-active cells on a second single frequency layer.

FIG. 18 illustrates a multi-frequency-layer activation MAC-CE, according to some embodiments. The MAC-CE of FIG. 18 may be used to achieve the activation of both configurations with respect to FIG. 17. The MAC-CE may activate the P/SP CSI report #1 (e.g., associated with deactivated type-2 SCell #1 and type-2 non-serving cell #2 on frequency layer #1) by using the following fields: C₁=1 and X_{1,0}=1. The MAC-CE may activate the P/SP CSI report #2 (e.g., associated with type-1 non-serving cells #3 and #4 on frequency layer #2) by using the following fields: C₂=1 and X_{2,0}=1. Note that, as shown, the multi-frequency-layer activation MAC-CE becomes 2 octets if the network only activates P/SP CSI reports on these two frequency layers, according to some embodiments.

As another possibility, for aperiodic (e.g., A-CSI) measurement and reporting associated with type-1 and/or type-2 cells a different activation framework may be used. One or more CSI triggering states may be associated with any candidate DL BWP on one or more non-active cell. Such triggering states may support L1-based cell switching, according to some embodiments. Alternatively, only a first (e.g., lowest index) active BWP on a type-2 cell may be linked with a CSI triggering state. This restriction may reduce signaling overhead relative to the more flexible (any BWP) approach.

A group of one or more measurement configuration may be configured as a triggering state, e.g., during 504/506. This grouping may be done by RRC or MAC-CE signaling. To trigger or activate the triggering state, the network may send a triggering message, e.g., in a MAC-CE or DCI. Such activation may trigger the UE to perform the measurements and transmit the triggered CSI report(s). The network may consider any aperiodicTriggeringOffset value provided for the UE for non-serving cells in setting the timing of when to transmit a trigger and/or when to anticipate a corresponding report.

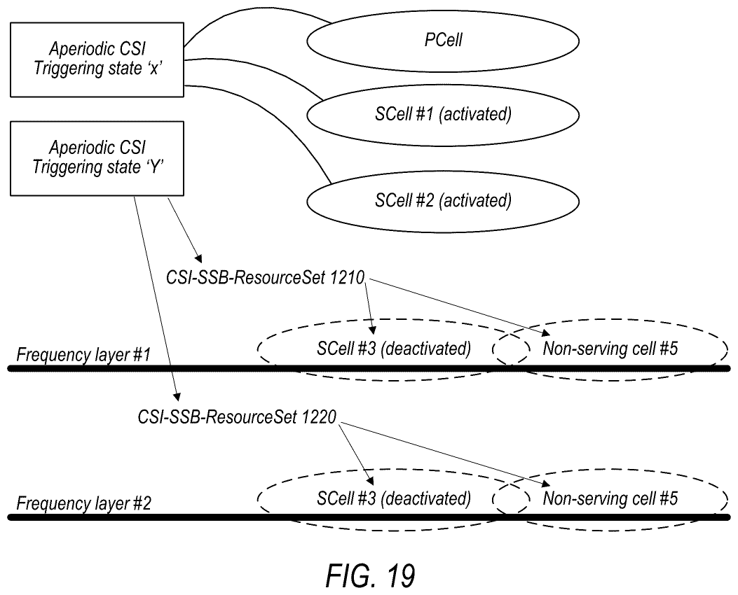

FIG. 19 illustrates aperiodic CSI triggering, according to some embodiments. Specifically, triggering state Y may include configurations for measuring CSI resources 1210 and 1220 on the type-2 SCells #3 and #4 and type-2 non-serving cells #5 and #6, respectively. Triggering state Y may be triggered together with or separately from state X (which includes measurements of various active serving cells).

In some embodiments, the UE may transmit, on the first cell, an indication that triggers an A-CSI reporting of one or more non-active inter-frequency cell(s) that have different frequency layers than the frequency layer of the first cell. The indication triggering the A-CSI reporting of non-active inter-frequency cells may comprise an indication of an aperiodic triggering offset (aperiodicTriggeringOffset) specific to non-active inter-frequency cells. In other words, instead of or in addition to indicating the offset in capability information (e.g., using RRC in 502), the UE may indicate the offset when triggering the A-CSI reporting.

It will be appreciated that either the UE or the network (or both) may trigger A-CSI reporting, using any configured triggering state. Thus, although 510 is shown as a signal from the network to the UE, UE initiated activation may also be used as desired.

The network may transmit reference signals (RS) (512), according to some embodiments. The RS may be transmitted by one or more non-active cells that do not overlap the frequency of any cells currently activated for the UE. The RS may be transmitted at the time and frequency locations (e.g., frequency layers, ARFCNS) for the activated measurement configurations. The RS may include CSI-RS, SSB, and/or other types of RS.

The UE may receive the RS and may use the RS for measurement(s) and to generate report(s) (514), according to some embodiments. For example, the UE may determine time and frequency locations of RS to measure (for L1 measurements, e.g., as may be used for LTM operation) based on the active measurement configuration(s) (e.g., based on signaling received from the network in 506 and/or 510). The UE may tune its receive circuitry to receive circuitry to those locations to receive the RS and perform L1 and/or other measurement(s) of the RS. Based on the received RS and/or associated measurements, the UE may generate one or more measurement report(s). The report(s) may be formatted based on the active measurement configuration(s).

The UE may transmit the measurement report(s) to the network (516), according to some embodiments. The report(s) may be transmitted according to the active measurement configuration(s). For example, the UE may determine time and frequency location(s), destination cell(s), and/or TCI(s) based on the active measurement configuration(s) and may transmit the report(s) accordingly. For example, the UE mat transmit the report(s) to the first cell, among various possibilities.

The UE and the network may perform LTM operation(s) (518), according to some embodiments. LTM operations may include L1 mobility such as adding/configuring, activating, switching, deactivating one or more cell(s), etc. The LTM operation(s) may be based on the L1 measurement(s) and/or measurement report(s). In some embodiments, LTM operations may be omitted.

Thus, at least according to some embodiments, the method of FIG. 5 may be used to provide a framework according to which a UE and network may configure, indicate, and/or activate L1 measurement configuration for non-serving cell(s), and thus to assist the network to effectively and efficiently schedule and perform wireless communications with the UE, at least in some instances.

It will be appreciated that although various examples are provided with respect to CSI-RS and/or SSB. The method of FIG. 5 may be applied to other types of RS as desired.

It will be appreciated that various actions (e.g., determinations, etc.) are discussed above as being performed by the network. Any component of the network (or combination of components) may perform these actions. For example, various determinations may be performed by a base station 102, core network element(s), controller, and/or other component.

In the following further exemplary embodiments are provided.

One set of embodiments may include a method. The method may include: establishing communication with a first activated serving cell of a cellular network, the first activated serving cell operating on a first frequency layer; receiving, from the first activated serving cell, configuration information for layer 1 (L1)/layer 2 (L2)-Triggered Mobility (LTM) operation comprising a L1 measurement configuration for a non-active second cell, the non-active second cell operating on a second frequency layer that is different from the first frequency layer; determining, based on the L1 measurement configuration, information for measuring reference signals (RS) transmitted on the non-active second cell for triggering LTM operation, the information for measuring RS on the non-active second cell for triggering LTM operation comprising at least one of: a frequency location of RS transmitted on the non-active second cell; or a subcarrier spacing of the RS transmitted on the non-active second cell; performing an L1 measurement of the non-active second cell according to the information for measuring the RS on the non-active second cell; and reporting the L1 measurement to the cellular network.

In some embodiments, reporting the L1 measurement to the cellular network comprises transmitting a report of the L1 measurement results associated with the non-active second cell on the second frequency layer to the primary serving cell on the first frequency layer.

In some embodiments, the L1 measurement configuration is received during a L1/L2-Triggered Mobility (LTM) operation preparation phase.

In some embodiments, the L1 measurement configuration comprises an information element indicating a single frequency layer location of the RS transmitted on the non-active second cell.

In some embodiments, the L1 measurement configuration comprises an information element indicating a plurality of frequencies layers, respective frequencies of the plurality of frequencies corresponding to respective additional cells for performing L1 measurement for L1/L2-Triggered Mobility (LTM) operation, wherein the non-active second cell is among the additional cells for L1 measurement.

In some embodiments, the information element comprises a synchronization signal block (SSB) frequency list (ssbFrequencyList), wherein respective entries on the ssbFrequencyList indicate a plurality of frequencies layers for respective physical cell identifier (PCI) entries that are included in the same channel state information (CSI)-SSB resource list (csi-SSB-ResourceList) by Radio Resource Control (RRC) signaling.

In some embodiments, the L1 measurement configuration comprises an information element indicating a single subcarrier spacing that is used by the RS transmitted on the non-active second cell.

In some embodiments, the L1 measurement configuration comprises an information element indicating a plurality of subcarrier spacings, respective subcarrier spacings of the plurality of subcarrier spacings corresponding to respective additional cells for measurement, wherein the non-active second cell is among the additional cells for measurement.

In some embodiments, the information element comprises a synchronization signal block (SSB) subcarrier spacing list (ssbSubcarrierSpacingList), wherein respective entries on the ssbSubcarrierSpacingList indicate respective subcarrier spacings for respective entries on a channel state information (CSI)-SSB resource list (csi-SSB-ResourceList).

In some embodiments, the first frequency layer is indicated by a first absolute radio-frequency channel number (ARFCN) value and the second frequency layer is indicated by a second ARFCN value.

In some embodiments, the method further comprising configuring one or more secondary cells, wherein the second frequency layer is not used by any cell of the one or more secondary cells.

In some embodiments, the method further comprising configuring one or more secondary cells, wherein the non-active second cell is one of the secondary cells and the non-active second cell is deactivated.

In some embodiments, the method further comprising configuring one or more periodic or semi-persistent channel state information (CSI) report for the non-active second cell, wherein the one or more periodic or semi-persistent CSI report is associated with RS on the non-active second cell for L1 measurement to trigger LTM operation.

In some embodiments, the L1 measurement configuration for the non-active second cell is included as part of configuration of the first activated serving cell.

In some embodiments, the L1 measurement configuration for the non-active second cell is included as part of configuration of the non-active second cell.

One set of embodiments may include a method. The method may include establishing communication with a user equipment (UE) via a first activated serving cell of a cellular network, the first activated serving cell operating on a first frequency layer; transmitting, to the UE from the first activated serving cell, configuration information for layer 1 (L1)/layer 2 (L2)-Triggered Mobility (LTM) operation comprising a L1 measurement configuration for a non-active second cell, the non-active second cell operating on a second frequency layer that is different from the first frequency layer, the L1 measurement configuration comprising information for measuring reference signals (RS) transmitted on the non-active second cell for triggering LTM operation, the information for measuring RS on the non-active second cell for triggering LTM operation comprising at least one of: a frequency location of RS transmitted on the non-active second cell; or a subcarrier spacing of the RS transmitted on the non-active second cell; receiving, from the UE, a report of an L1 measurement of the non-active second cell according to the information for measuring the RS on the non-active second cell.

One set of embodiments may include a method. The method may include: establishing communication with a first activated serving cell of a cellular network, the first activated serving cell operating on a first frequency; receiving, from the first activated serving cell, configuration information for layer 1 (L1)/layer 2 (L2)-Triggered Mobility (LTM) operation comprising a first L1 measurement configuration for a non-active second cell, the non-active second cell operating on a second frequency layer that is different from the first frequency; and in response to an indication specifying the second frequency layer: performing an L1 measurement according to the first L1 measurement configuration for the non-active second cell; and reporting the L1 measurement to the cellular network.

In some embodiments, the method further comprising configuring one or more secondary cells, wherein: the second frequency layer of the non-active second cell is not used by any cell of the one or more secondary cells; and the indication specifying the second frequency layer comprises a virtual frequency layer identifier (VFID) that is configured by radio resource control (RRC) signaling and is associated with the second frequency layer.

In some embodiments, the VFID of the non-active second cell is one of a plurality of VFIDs sequentially indexed after the indices of the one or more secondary cells.

In some embodiments, the VFID of the non-active second cell is one of a plurality of VFIDs sequentially indexed starting from 0 and independent of the indices of the one or more secondary cells.

In some embodiments, the indication comprises a media access control (MAC) control element (MAC-CE) indicating a single frequency layer, wherein the single frequency layer comprises the second frequency layer.

In some embodiments, the configuration information comprises a plurality of L1 measurement configurations for the non-active second cell on the second frequency layer; and the MAC-CE indicates respective activation/deactivation statuses for respective L1 measurement configurations of the plurality of L1 measurement configurations of the non-active second cell and the non-active second cell is identified by an additional physical cell identity (PCI) index configured by radio resource control (RRC) signaling.

In some embodiments, the configuration information comprises respective L1 measurement configurations for respective cells of a plurality of cells, the plurality of cells comprising the non-active second cell; and the indication comprises a media access control (MAC) control element (MAC-CE) indicating a plurality of activation/deactivation statuses, respective activation/deactivation statuses of the plurality of activation/deactivation statuses corresponding to respective L1 measurement configurations of the plurality of L1 measurement configurations associated with the plurality of cells on one or more frequency layers including the second frequency layer.

In some embodiments, the method further comprising one or more frequency layer specified by the MAC-CE indication is indicated using a bitmap field C, wherein: Cᵢ indicates an ith frequency layer of a secondary cell with SCell index=i or virtual frequency layer identifier (VFID)=i; Cᵢ=1 means an L1 measurement configuration is activated for the ith frequency layer; and Cᵢ!=1 means an L1 measurement configuration is not activated for the ith frequency layer.

In some embodiments, the configuration information comprises a plurality of L1 measurement configurations for the non-active second cell on the second frequency layer; and the plurality of activation/deactivation statuses comprises respective activation/deactivation statuses for respective L1 measurement configurations for the non-active second cell with one-to-one mapping between a respective 1-bit fields and respective L1 measurement configurations.

In some embodiments, the first L1 measurement configuration comprises an aperiodic channel state information (A-CSI) report configuration; and the indication specifying the second frequency layer comprises a downlink control information (DCI) message that includes a channel state information (CSI) request field.

In some embodiments, the method further comprising: transmitting, on the first activated serving cell, an indication that triggers an A-CSI reporting of non-active inter-frequency cells that have different frequency layers than the frequency layer of the first activated serving cell.

In some embodiments, the indication triggering an A-CSI reporting of deactivated inter-frequency cells comprises an indication of an aperiodic triggering offset specific to non-active inter-frequency cells.

In some embodiments, the configuration information comprises a plurality of L1 measurement configurations, the plurality of L1 measurement configurations comprising respective L1 measurement configurations for respective cells of a plurality of cells, the plurality of cells comprising the non-active second cell; and the indication comprises a trigger state that is associated by radio resource control (RRC) signaling with multiple L1 measurement configurations of the plurality of L1 measurement configurations.

In some embodiments, the method further comprising: transmitting, on the first activated serving cell, an indication that triggers an aperiodic channel state information (A-CSI) report of the non-active second cell.

In some embodiments, the indication that triggers the A-CSI report of the non-active second cell comprises an indication of an aperiodic triggering offset specific to non-active inter-frequency cells.

One set of embodiments may include a method. The method may include: establishing communication with a user equipment (UE) via a first activated serving cell of a cellular network, the first activated serving cell operating on a first frequency; transmitting, to the UE from the first activated serving cell, configuration information for layer 1 (L1)/layer 2 (L2)-Triggered Mobility (LTM) operation comprising a first L1 measurement configuration for a non-active second cell, the non-active second cell operating on a second frequency layer that is different from the first frequency; determining to activate the first L1 measurement configuration for the non-active second cell; in response to the determination to activate the first L1 measurement configuration for the non-active second cell, transmitting to the UE an indication specifying the second frequency layer; and receiving, from the UE, a report of an L1 measurement according to the first L1 measurement configuration for the non-active second cell.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Y et another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method, comprising:
establishing communication with a first serving cell of a cellular network, the first serving cell operating on a first frequency layer;
receiving, from the first serving cell, a L1 measurement configuration information for layer 1 (L1)/layer 2 (L2)-Triggered Mobility (LTM) operation during a LTM operation preparation phase comprising for a second cell;
determining, based on the L1 measurement configuration, information for measuring a synchronization signal blocks (SSB) transmitted on the second cell, the information for measuring SSB on the second cell comprising:
an absolute radio-frequency channel number (ARFCN) of the SSB on the second cell;
a subcarrier spacing associated with the SSB on the second cell; and
an SSB index to specify a particular SSB instance on the second cell; and
performing an L1 measurement on the second cell according to the information for measuring the SSB on the second cell; and
reporting the L1 measurement to the cellular network.

22. The method of claim 21, wherein the L1 measurement configuration comprises a channel state information (CSI) SSB resource set, wherein the CSI SSB resource set includes a list of SSB indices, wherein the list includes the SSB index to specify a particular SSB instance on the second cell.

23. The method of claim 22,
wherein a same number of physical cell ids (PCIs), ARFCNs, SCSs, are indicated as the number of SSB indices indicated in the list.

24. The method of claim 21, wherein the L1 measurement configuration comprises a channel state information (CSI) SSB resource set providing an indication a plurality of additional cells for LI measurements for LTM operation, wherein the plurality of additional cells includes the second cell.

25. The method of claim 24, wherein for each the plurality of additional cells indicated by the CSI SSB resource set, a respective physical cell id (PCI), ARFCN, SCS, and SSB index are also indicated.

26. The method of claim 21, further comprising:
receiving a configuration a periodic or semi-persistent channel state information (CSI) report for the second cell, wherein the periodic or semi-persistent CSI report is associated with SSB on the second cell for LI measurement for LTM operation.

27. The method of claim 26, further comprising:
receiving a medium access control (MAC) control element (MAC-CE) indicating a one or more activation/deactivation statuses including a status for the periodic or semi persistent CSI reports for the second cell, wherein the MAC CE includes a serving cell ID, bandwidth part ID, and the one or more activation/deactivation statuses, wherein the one or more activation/deactivation statuses correspond to an ordering of CSI report configuration IDs, wherein a zeroth activation/deactivation status in the MAC CE corresponds to CSI resources in the bandwidth part ID that have a lowest CSI report configuration ID.

28. The method of claim 21, wherein the second cell is a non-active cell.

29. A method, comprising:
establishing communication with a user equipment (UE) via a first serving cell of a cellular network, the first serving cell operating on a first frequency layer;
transmitting, to the UE from the first serving cell, a L1 measurement configuration information for layer 1 (L1)/layer 2 (L2)-Triggered Mobility (LTM) operation during a LTM operation preparation phase comprising for a second cell, the L1 measurement configuration comprising information for measuring a synchronization signal blocks (SSB) transmitted on the second cell, the information for measuring SSB on the second cell providing an indication of:
an absolute radio-frequency channel number (ARFCN) of the SSB on the second cell;
a subcarrier spacing associated with the SSB on the second cell; and
an SSB index to specify a particular SSB instance on the second cell; and
receiving, from the UE, a report of an L1 measurement on the second cell according to the information for measuring the SSB on the second cell.

30. The method of claim 29, wherein the L1 measurement configuration comprises a channel state information (CSI) SSB resource set, wherein the CSI SSB resource set includes a list of SSB indices, wherein the list includes the SSB index to specify a particular SSB instance on the second cell.

31. The method of claim 30,
wherein a same number of physical cell ids (PCIs), ARFCNs, SCSs, are indicated as the number of SSB indices indicated in the list.

32. The method of claim 29, wherein the L1 measurement configuration comprises a channel state information (CSI) SSB resource set providing an indication a plurality of additional cells for LI measurements for LTM operation, wherein the plurality of additional cells includes the second cell.

33. The method of claim 32, wherein for each the plurality of additional cells indicated by the CSI SSB resource set, a respective physical cell id (PCI), ARFCN, SCS, and SSB index are also indicated.

34. The method of claim 29, further comprising
transmitting, to the UE, a configuring of a periodic or semi-persistent channel state information (CSI) report for the second cell, wherein the periodic or semi-persistent CSI report is associated with SSB on the second cell for LI measurement for LTM operation.

35. The method of claim 34, further comprising:
transmitting, to the UE, a medium access control (MAC) control element (MAC-CE) indicating a one or more activation/deactivation statuses including a status for the periodic or semi persistent CSI reports for the second cell, wherein the MAC CE includes a serving cell ID, bandwidth part ID, and the one or more activation/deactivation statuses, wherein the one or more activation/deactivation statuses correspond to an ordering of CSI report configuration IDs, wherein a zeroth activation/deactivation status in the MAC CE corresponds to CSI resources in the bandwidth part ID that have a lowest CSI report configuration ID.

36. The method of claim 29, wherein the second cell is a non-active cell.

37. An apparatus, comprising:
a processor configured to, when executing instructions stored in a memory, perform operations comprising:
establishing communication with a first serving cell of a cellular network, the first serving cell operating on a first frequency layer;
receiving, from the first serving cell, a L1 measurement configuration information for layer 1 (L1)/layer 2 (L2)-Triggered Mobility (LTM) operation during a LTM operation preparation phase comprising for a second cell;
determining, based on the L1 measurement configuration, information for measuring a synchronization signal blocks (SSB) transmitted on the second cell, the information for measuring SSB on the second cell comprising:
an absolute radio-frequency channel number (ARFCN) of the SSB on the second cell;
a subcarrier spacing associated with the SSB on the second cell; and
an SSB index to specify a particular SSB instance on the second cell; and
performing an L1 measurement on the second cell according to the information for measuring the SSB on the second cell; and
reporting the L1 measurement to the cellular network.

38. The apparatus of claim 37, wherein the L1 measurement configuration comprises a channel state information (CSI) SSB resource set, wherein the CSI SSB resource set includes a list of SSB indices, wherein the list includes the SSB index to specify a particular SSB instance on the second cell.

39. The apparatus of claim 38,
wherein a same number of physical cell ids (PCIs), ARFCNs, SCSs, are indicated as the number of SSB indices indicated in the list.

40. The apparatus of claim 37, further comprising a radio communicatively coupled to the processor.
